(19) United States
(12) Patent Application Publication
(10) Pub. No.: US 2003/0091888 A1
(43) Pub. Date: May 15, 2003

(54) High-density, wireless fuel cell power unit

(76) Inventor: Christopher M. Goggin, Wilmington, NC (US)

Correspondence Address: Michael E. Mauney, Attorney at Law, Post Office Box 10266, Southport, NC, 28461, US

(21) Appl. No.: 10/294,869

(22) Filed: Nov. 14, 2002

Related U.S. Application Data
(60) Provisional application No. 60/336,186, filed on Nov. 15, 2001.

(51) Int. Cl. H01M 8/02; H01M 8/24; H01M 4/86; H01M 8/04

(52) U.S. Cl. 429/38; 429/32; 429/40; 429/22

(57) ABSTRACT

A fuel cell design for ease of combination stacking with a high intensity output. A fuel cell is designed so that they can be arranged in series with the anode plate of one adjacent to the cathode plate of another. Each fuel cell produces a particular voltage. To achieve a total voltage, a particular number of fuel cells are wired in series that add up to desired total voltage. An oxygen bearing gas enters the individual fuel cells on one side with interaction with a membrane electrodeassembly. This allows for easy arrangement of fuel cells on an oxygen distributing manifold with stacks above and below the manifold. Hydrogen is distributed to the membrane electrodeassembly through bores in the fuel cell members so that hydrogen can be easily distributed to all fuel cells in a particular stack through a manifold beginning at an end of each fuel cell stack.

### TECHNICAL FIELD

This invention relates generally to a fuel cell device to deliver electric power to household appliances at or near household current, voltages, and amperages. More specifically, it is a portable fuel cell power supply of approximately twelve cubic inches in volume, which with a fuel supply can deliver household currents for such appliances as toasters, hair dryers, blenders, or other home devices which require household current and voltages for the life of the fuel supply.

### RELATED APPLICATION

This invention was described in my provisional patent application No. 60/336,186, accorded a filing date of Nov. 15, 2001.

### BACKGROUND OF THE INVENTION

Fuel cells are sometimes described as continuously operating batteries or an electrochemical current producing engine. Like a battery a fuel cell can produce electrical power without apparent combustion or rotating machinery. A fuel cell will typically make electricity by combining hydrogen ions drawn from a hydrogen containing fuel with oxygen atoms. Consequently, a fuel cell can produce power continuously as long as it is supplied with hydrogen ions and oxygen atoms.

Typically, a fuel cell uses ingredients that create chemical reactions that produce hydrogen or oxygen bearing ions which may pass through an electrolyte to produce an electric current at both the anode and cathode. The result is an electric current with a potential for waste heat and water vapor as exhaust products. Ordinarily, for each fuel cell the voltage is limited to around one volt per electrode pair or fuel cell. However, cells can be stacked or wired in series until the desired power level is reached. Thus, achieving desirable voltages is ordinarily a simple matter of cell design.

The current is proportional to the size or area of the electrode. Achieving current or flow rates at sufficient density to be useful for standard household appliances that require high energy (greater than 1000 watts) in a small compact portable unit has proven to be a difficult challenge for designers. If a design can achieve 500 milliamps per square centimeter of fuel cell area, it becomes possible to design a fuel cell “stack” that is comparable in size to portable batteries

One well known type of fuel cell includes a membrane electrodeassembly (MEA), which is typically a thin, proton transmissive, solid polymer membrane electrolyte having an anode on one of its faces and a cathode on the opposite face. The MEA is sandwiched between a pair of electrically conductive elements, which serve as current collectors for the anode and cathode. There must be appropriate channels and/or openings for distributing the fuel cell's gassant reactants over the surfaces of the respective anode and cathode catalyst. These MEA units are typically stacked or ganged together to form a fuel cell stack or assembly. The individual MEA cells can be electrically connected by connecting the anode current collector of one cell with the cathode current collector of the nearest neighbor in the fuel cell stack.

### SUMMARY OF THE INVENTION

The current invention uses a carefully designed fuel cell stack container, which allows the hydrogen fuel to freely flow through manifolds to the anode side of the MEA. On the cathode side of the MEA pressurized, ionized air is provided. All components except current carrying components are molded plastic for their light weight and for their electrical and heat insulating properties. The stack container is designed to maximize the efficiency of the cathode current production by use of the pressurized, ionized air. Hydrogen flow to the anode is controlled by a fuel delivery regulator used to regulate the flow of hydrogen from a hydrogen source and to control the pressure of the hydrogen to increase the efficiency of the anode side of the MEA. Typically, a regulator will be part of or controlled by a solid state circuit. The solid state circuit control system will not be described, but one of skill in the art will readily appreciate that such a circuit is not complex and is a matter of use of conventional, high resolution, printed circuit board technology. Moreover, the control circuitry can be useful for starting the fuel cell from the dormant state, for monitoring and adjusting operation of the fuel cell, and for emergency shut down. Typically, a small portable power supply such as a battery is used to “boot up” the control circuit to start the fuel cell from a dormant state. This design can achieve up to 0.95 volts per fuel cell. If 127 fuel cells of this design are wired in series, up to the standard United States household voltage of 120 volts is obtained. The fuel cell of this design can achieve up to 1000 milliamps of current per square centimeter of MEA surface in fuel cell. Thus, a fuel cell stack of this design may be compact and portable but supply power sufficient to operate small appliances requiring hundreds of watts.

### BRIEF DESCRIPTION OF THE DRAWINGS

FIG. 1A is an exploded view of a single MEA fuel cell showing the hydrogen intake and manifold when seen from the anode side of the MEA.

FIG. 1B is an exploded view of a single fuel cell showing the cathode as seen from the cathode side of the MEA.

FIG. 1C is an exploded view of an alternate embodiment of the fuel cell.

FIG. 1D is a cut-a-way view of an alternate of the anode plate of the fuel cell.

FIG. 1E is a view of an alternate of the anode insulator of the fuel cell.

FIG. 2 is a partially assembled single MEA fuel cell showing air flow over the cathode side of the MEA.

FIG. 3 is a cut-a-way view of a single fuel cell showing the air flow over the cathode side of the MEA.

FIG. 4 is a fuel cell stack box.

FIG. 5A shows the high-density fuel cell power unit with the fuel supply control elements connected to one of the fuel supply inlets.

FIG. 5B shows the high-density fuel cell power unit with the air pump and ionizer.

### DETAILED DESCRIPTION OF THE DRAWINGS

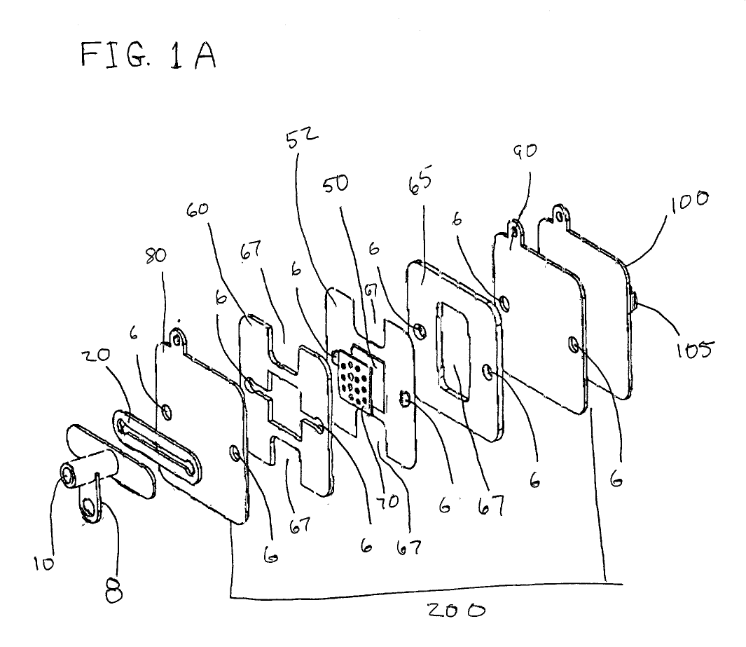

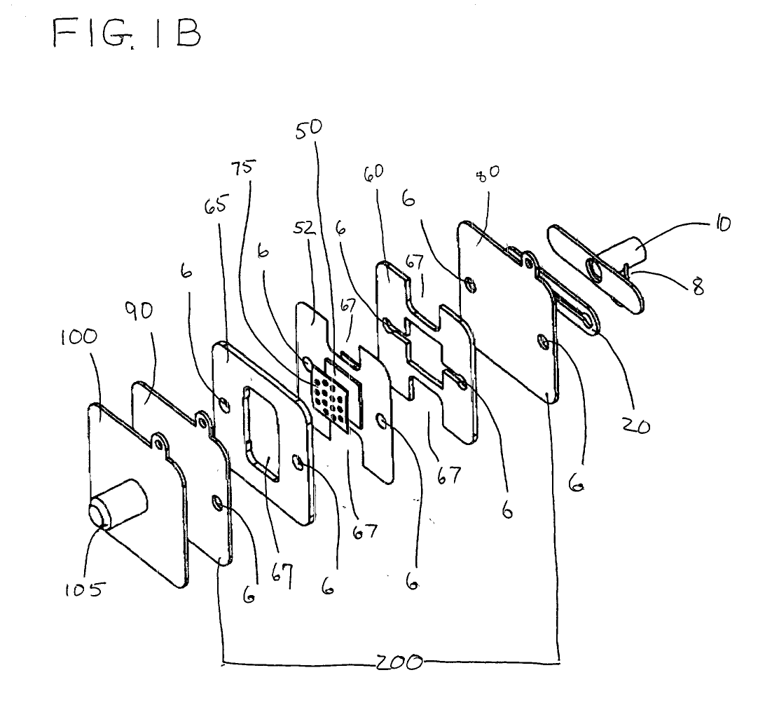

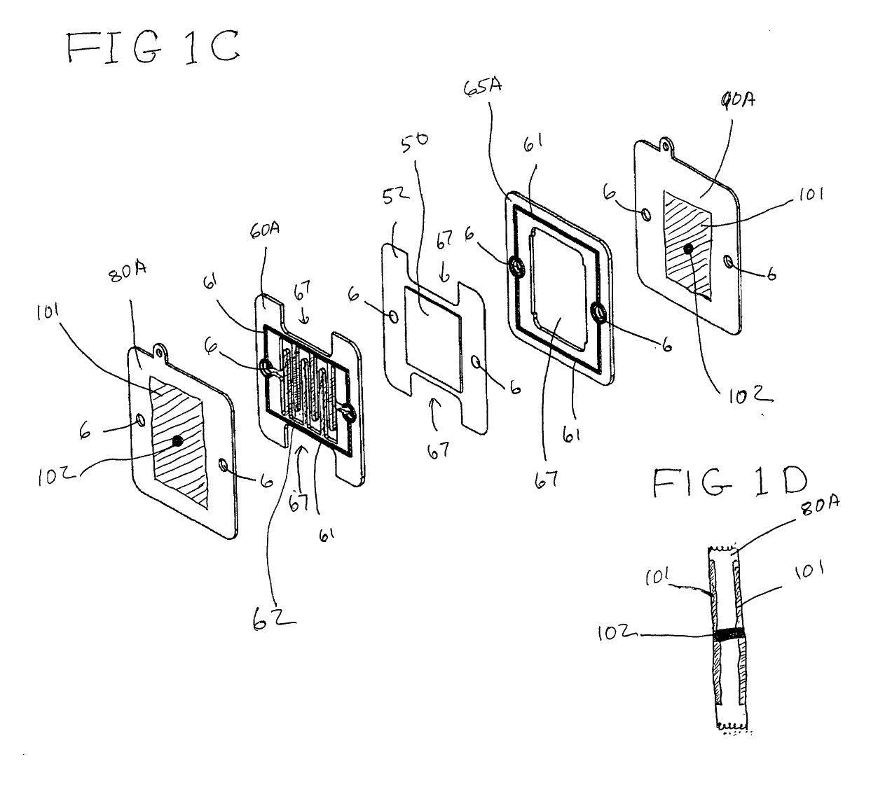

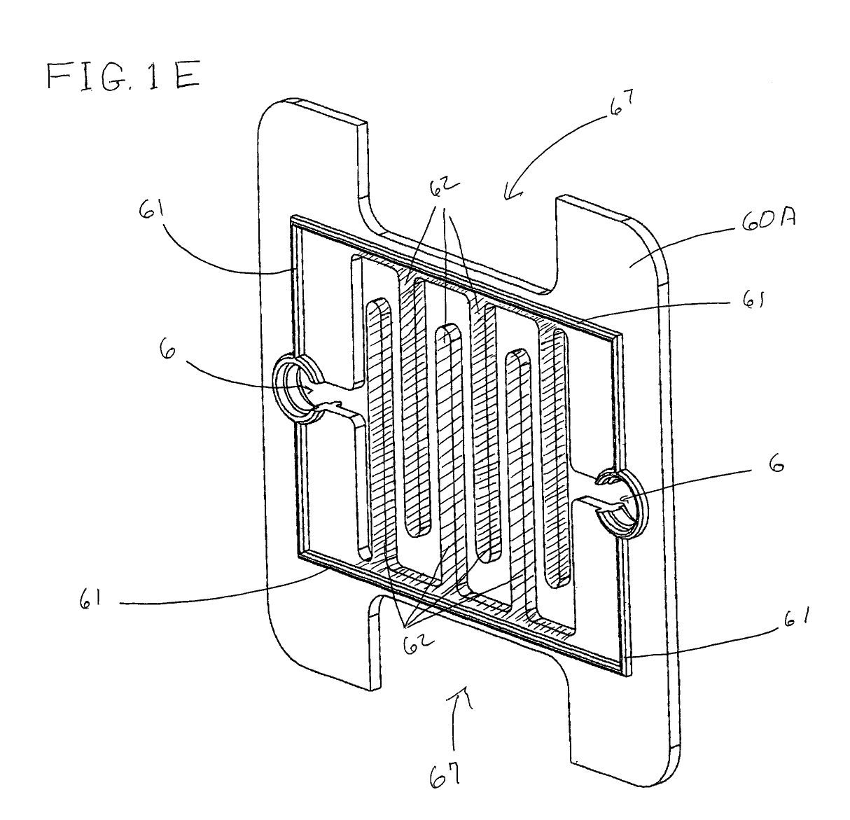

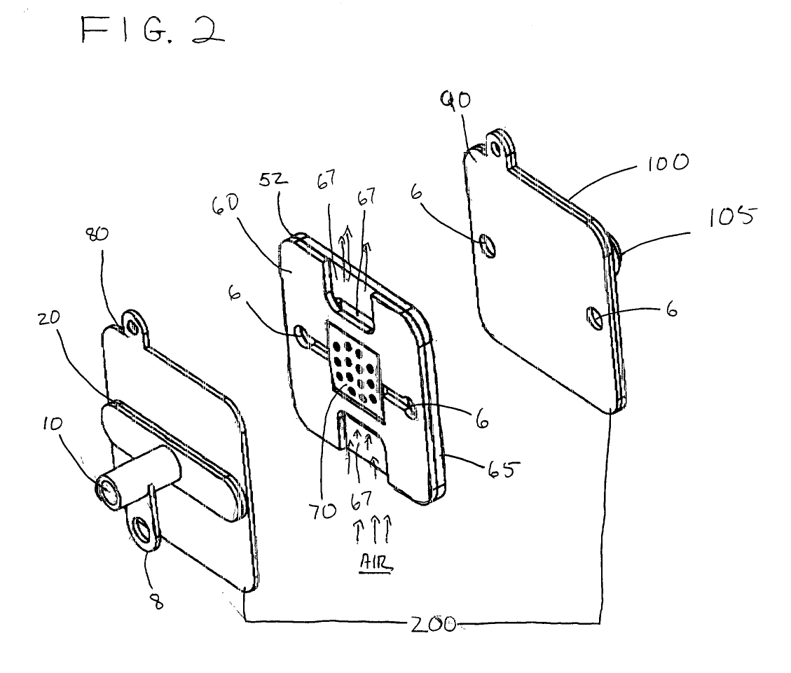

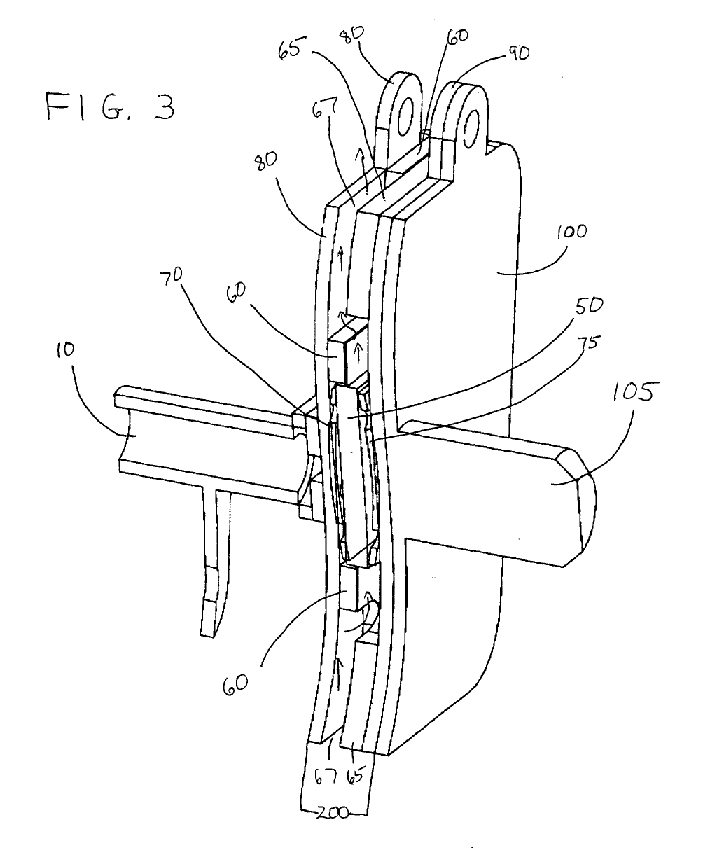

FIG. 1A shows an exploded view of a fuel cell (200). Individual fuel cells (200) can be assembled into a fuel cell stack as will be shown in later drawings. A fuel inlet (10) is simply a tube leading to a manifold (20) which splits the fuel (usually hydrogen) flow into two separate streams which will be transmitted throughout the fuel cell stack through channels (6). The anode connection lug (8) is attached to the fuel inlet (10). The membrane electrodeassembly or MEA (50) is seen in the middle of the fuel cell (200). The MEA (50) is, in part, a small sheet of polymer electrolyte membrane. Ordinarily, fuel in the form of hydrogen is supplied to one side of the polymer electrolyte membrane and an oxidant, ordinarily an oxygen containing gas such as ambient air, is supplied to the other side of the polymer electrolyte membrane. In a polymer electrolyte membrane fuel cell, the membrane is usually coated on both sides with a catalyst, typically a platinum or palladium mixture to form an electrode. Electrodes of the MEA (50) serve several functions. Oxygen and hydrogen diffuse evenly across the surface of the MEA (50). The MEA (50) must allow water to escape. It must catalyze the reactions. It must conduct electrons to complete an electrical circuit and conduct protons to the membrane. In addition to the coated membrane, there is usually a gas diffusion layer on both sides of the membrane. Typically, these diffusion layers consist of some kind of carbon fiber or carbon coated paper. Typically, the diffusion layers are incorporated as part of the electrodes of the MEA (50). Either side of the MEA (50) can serve as an anode or as a cathode. Whatever side of the MEA (50) that is exposed to the hydrogen fuel is the anode, while the opposite side will necessarily be exposed to the oxidizer, an oxygen containing gas. In the fuel cell (200) (shown in FIG. 1A) theoretically, either side of the MEA (50) could serve as an anode and either side could serve as a cathode. However, practically, as will be explained later, the particular design of the fuel cell (200) requires, because of the need to distribute the fuel (hydrogen) and of the oxidant (air) and to avoid mixing the two gases, that the anode and cathode sides of the device are fixed by the design. Here the anode side of the MEA (50) is shown. A spring-loaded conductive mesh (70) made of non-corrosive durable materials, such as a stainless steel screen-like material, will be placed on the anode side of the MEA (50). This conductive mesh (70) is spring loaded and will conductively connect to the conductive anode plate (80) for transmission of current from the anode side of the MEA (50) to the anode plate (80). Here, the conductive mesh (70) on the anode side of the MEA (50) will allow distribution of fuel (hydrogen) to the anode side of the MEA (50) easily, while at the same time conducting excess electrons from the MEA (50) to the conductive anode plate (80). The anode insulator (60) serves to distribute the fuel flow through the channel (6) to the anode side of the MEA (50). The MEA (50) is mounted on the MEA mounting film (52) which is very thin. The mounting film (52) has channels (6) for passage of the hydrogen gas to the next fuel cell in the stack. The anode insulator (60), the MEA mounting film (52), and cathode insulator (65) all have air slots (67) for passage of air over the cathode side of the MEA (50) as shown in FIGS. 2 and 3.

FIG. 1B shows the fuel cell (200) seen from the cathode side. Here, the cathode plate (100) with the cathode lug (105) is clearly seen. At the opposite end is the fuel inlet (10) with the anode lug (8) and the manifold (20). Here, the cathode conductive plate (90) is seen next to the cathode insulator (65). A cathode conductive mesh (75) mounts against the cathode side of the MEA (50) on the MEA mounting film (52). The spring-mounted conductive mesh (75) conducts current from the MEA (50) to the cathode conductive plate (90). The cathode insulator (65) separates the MEA mounting film (52) from the cathode conductive plate (90). Thus, a single fuel cell (200) consists of an anode conductive plate (80), a cathode conductive plate (90), an anode insulator (60), a cathode insulator (65), an anode conductive mesh (70), a cathode conductive mesh (75), a MEA (50), and a MEA mounting film (52). Shown in both FIGS. 1A and 1B are the anode lug (8) and the cathode lug (105). However, an entire series of fuel cells could be stacked between the anode lug (8) and the cathode lug (105). The channels (6) would serve to distribute the hydrogen gas or other fuel to the anode side of the MEA (50) in the stack, while the oxygen would be distributed through the slots (67) seen in the anode insulator (60) and the MEA mounting film (52) and the cathode insulator (65) to the cathode side of the MEA (50). This will be seen more clearly in FIG. 2.

The fuel cell (200) is shown in FIGS. 1A and 1B as a highly, efficient design that allows for a peak and continuous performance not seen in prior designs. FIG. 1C shows an alternative embodiment of the fuel cell (200A). As with the fuel cell (200) shown in FIGS. 1A and 1B, there is a conductive anode plate (80A) and a conductive cathode plate (90A). The conductive anode plate (80A) and cathode plate (90A) will ordinarily be constructed of plastic, which may be non-conductive. However, to facilitate the wiring in series of fuel cells (200A) a metallized portion (101), shown by cross hatching, will be placed in an appropriate center area on both sides of the conductive anode plate (80A) and the conductive cathode plate (90A). An area of the conductive plate (80A) will be coated with an appropriate metal coating on both sides of the plate, as is shown in FIG. 1C. In order that electricity be conducted from the metallized portion (101), on one side of the plate to another side a metal feed pin (102) will connect the metallized portion (101) on each side of the conductive anode plate (80A) and conductive cathode plate (90A). FIGS. 1D shows in cut-a-way the conductive anode plate (80A). It will be appreciated that the conductive cathode plate (90A) would look the same in cut-a-way. The metallized portion (101) is shown on both sides of the conductive anode plate (80A). These metallized portions (101) are connected by the metal pin (102). This simply means that current will flow from one metallized portion (101) to the other metallized portion (101) on opposite sides of the conductive anode plate (80A), and through similar construction, on the conductive cathode plate (90A). Both the anode insulator (60A) and the cathode insulator (65A) also are changed in construction. The anode insulator (60A) has the largest changes and it is shown in more detail in FIG. 1E. Fuel (usually, hydrogen gas) is transmitted through channels (6) in the conductive anode plate (80A) to the anode insulator (60A). Fuel must be distributed over the anode side of the MEA (50), but fuel must not be allowed to leak outside the appropriate area and come in contact with the oxygen containing gas or air, causing a volatile and combustible hydrogen/oxygen/gas mixture. To that end, a plastic bead (61A) is placed around the surface of both the anode insulator (60A) and the cathode insulator (65A) and on both sides. On the anode insulator (60A), the plastic bead (61A) seals the central portion which has a metallized grill work (62) for distribution of hydrogen gas or fuel to the anode side of the MEA (50). As will be noted, this plastic bead (61A) separates the area of hydrogen gas or fuel distribution from the slot (67) which is for passage of an oxygen containing gas or air. This plastic bead (61A) is on both sides of the anode insulator (60A) and on both sides of the cathode insulator (65A) although only one side is shown in FIG. 1C and FIG. 1E. The metallized grill (62) provides for an electrical contact between the metallized portion (101) of the anode conductor plate (80A) and the MEA (50). In fuel cell (200A) the anode conductive mesh (70) will be omitted. Not shown in FIGS. 1C, 1D, and 1E, is the cathode conductive mesh (75). This will continue to be used in fuel cell (200A) to provide a conductive connection between the cathode side of the MEA (50) and the cathode conductive plate (90A). The cathode conductive mesh (75) not only serves the purpose of providing an electrical connection, but also provides an extra mass for cooling the cathode side of the MEA (50) and provides extra surface for evaporation of waste water which accumulates on the cathode side of the MEA (50). The extra surface provided by the cathode conductive mesh (75) is exposed to the airflow passing through the cathode side of the MEA (50) through the slot (67) to increase evaporation and cooling on the cathode side of the MEA (50). The use of the metallized portions (101) and the metal pin (102) along with the metallized grill (62) and the conductive mesh (75) provides for a conductive connection between the anode conductive plate (80A) and the cathode conductive plate (90A). When the fuel cell (200A) is appropriately assembled, it is exposed to an ultrasonic energy, which “welds” the fuel cell (200A) together using the plastic bead (61). This provides for a gas tight seal so that the hydrogen fuel passing through channels (6) cannot mix with the air passing through the slot (67) and effectively seals the anode side of the MEA (50) from the cathode side of the MEA (50) for gas leaks. At the time of the “welding” of the fuel cell (200A) together using the plastic bead (61), the fuel cell (200A) is placed under a particular pressure. This pressure remains constant for each fuel cell (200A) as it is assembled. This assures appropriate electrical connection between the cathode conductive plate (80A), the anode conductive plate (90A), the MEA (50), and with the conductive mesh (75), when pressurized to make sure there is contact between the metallized portion (101) on the anode conductive plate (80A) and the MEA (50).

FIG. 2 shows a partially assembled fuel cell (200) from the same perspective as shown in FIG. 1A of the anode lug (8) end. The hydrogen inlet (10) is now attached to the manifold (20), which is attached to the anode conductive plate (80). The anode conductive plate (80) is separated from the rest of the fuel cell (200) by a distance to more clearly visualize the assembly of the anode insulator (60), the MEA mounting film (52), and the cathode insulator plate (65). The MEA mounting film (52) is so thin that it is not shown with a dimension in FIG. 2 but is simply the line between the anode insulator (60) and the cathode insulator (65). It is typically a very thin plastic film. Air, preferably ionized, is forced in the direction shown by the arrows from a side of the fuel cell assembly (200). The air passes into the air slots (67) on the anode insulator (60), to flow into the slot (67) on the cathode insulator (65), to flow over the cathode side of the MEA (50). It then emerges from the upper side of the air slot (67) on the cathode insulator (65) to flow up and out of the fuel cell assembly (200) on the slot (67) on the anode insulator (60). It will be easily appreciated that a fuel cell stack of many fuel cells (200) could be made simply by inserting other fuel cells between anode lug (8) and the cathode lug (105). The fuel channels (6) will transport fuel to all fuel cells (200) in the stack. It will be appreciated that when more than one fuel cell (200) is stacked together, they must be tightly stacked or molded together so that the fuel channel (6) will only transport fuel to the anode side of the MEA (50)—that is, the stack of fuel cells (200) must be gas tight so that fuel will only go to the anode side of the MEA (50) throughout the stack and there is no leakage of fuel (hydrogen gas) out of the fuel cell stack. As was explained for the alternate design fuel cell (200A), a plastic bead (61) may provide a “weld” to reduce fuel leakage. This is in contrast to the cathode side of the MEA (50). On the cathode side of the MEA (50), air freely passes through the air slots (67) to flow over the cathode side of the MEA (50). As a waste product, water is produced on the cathode side of the MEA (50). Consequently, the amount of water allowed to accumulate on the cathode side of the MEA (50) must be carefully regulated, which can be done by controlling the rate of flow of air through the slot (67) across the cathode side of the MEA (50). As was explained for fuel cell (200A), the cathode conductive mesh (75) will serve to cool and evaporate waste water from the cathode side of the MEA (50). The flow of air through the slot (67) serves both to conduct waste water and heat away from the cathode side of the MEA (50), but also to make sure that appropriate amounts of waste water are held back to keep the MEA (50) wet and efficient.

FIG. 3 shows an assembled fuel cell (200) in cut-a-way. The slots (67) in the anode insulator (60) are seen at the top and bottom of FIG. 3 next to the anode collector plate (80). Air flow through these slots are indicated by the arrows. The anode insulator (60) is positioned between the anode collector plate (80) and the MEA film (52), which again cannot be seen because it is so thin. Air flows up the slot (67) cut in the anode insulator (60) to the air slot (67) in the cathode insulator (65) where it is directed over the cathode side of the MEA (50) where it flows to the top of the cathode insulator (65) air slot (67) and then is redirected through the air slot (67) on the anode insulator (60) and out of the fuel cell. Air flow is shown by the arrows. It will be understood the air flow direction can be reversed without affecting the function of the fuel cell (200). The anode conductive mesh (70) and cathode conductive mesh (75) are shown next to the MEA (50). FIG. 3 is primarily to show the air flow through the fuel cell (200). Air flow will follow the same path in fuel cell (200A) seen in FIG. 1C.

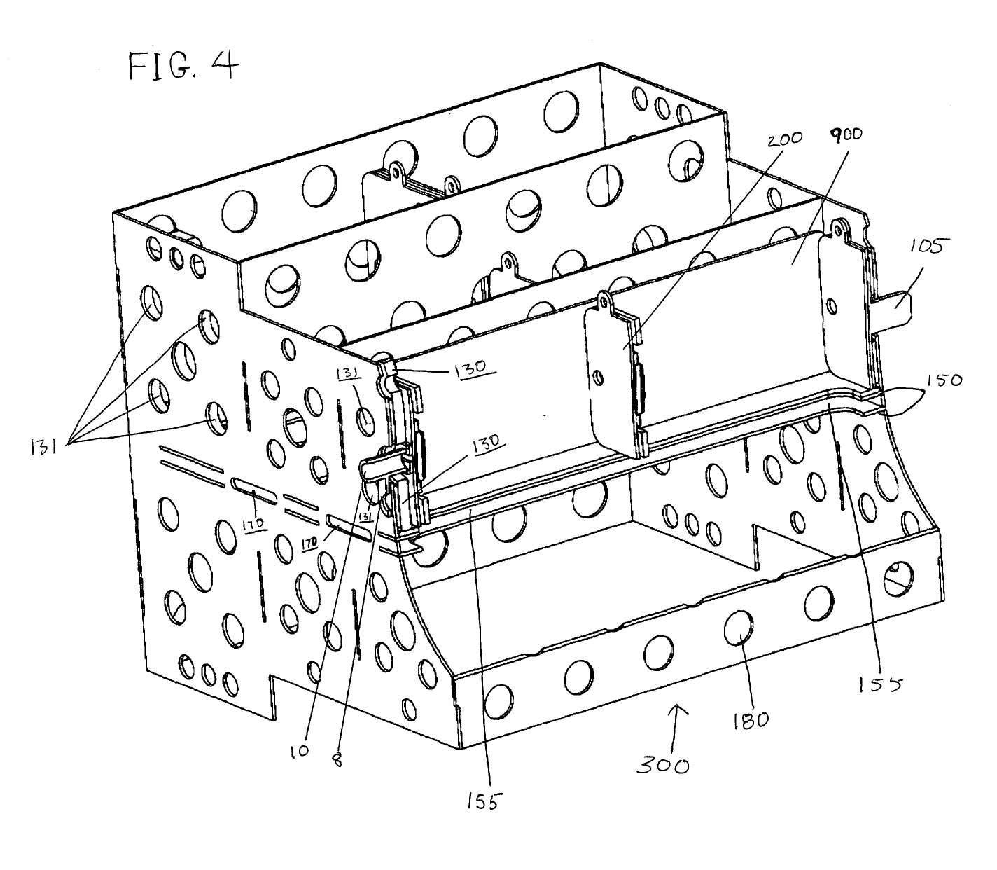

FIG. 4 shows a fuel cell stack box (300) with a portion of two rows of fuel cell stacks cut-a-way for visualization. For this particular application, the fuel cell stack box (300) holds stacks of fuel cells (200) into place. Typically, there will be stacks of fuel cells (200) arranged in rows and columns. Here, an upper column is cut-a-way for ease of visualization. The hydrogen inlet (10) along with the anode lug (8) are cut-a-way at one end of a stack of fuel cells (200) at one end of the fuel cell stack box (300). The fuel cells (200) are inside insulators (900). These insulators (900) will typically be a thin natural insulating material like mica. The stack of fuel cells (200) could be molded into a brick with an insulator (900) cover. It will be appreciated by one of skill in the art that the entire stack or row of fuel cells (200) contained within the insulators (900) will be wired in series. If 30 fuel cells (200) are wired together with each fuel cell (200) producing approximately one volt, then each row will produce approximately 30 volts. Four rows wired together would produce 120 volts. Thus, a definite number of fuel cells (200) are required to produce a particular voltage for a stack of fuel cells (200). The fuel inlet (10) will allow a fuel (typically, hydrogen) to pass through the stack of fuel cells (200) in each row. There are base plates (150) at the bottom of the fuel cells (200), as seen in FIG. 4. Ionized air will be forced through the air slots (170), thus pressurizing the space (155) with air inside the two base plates (150). The air will then feed into and through the fuel cells (200), as seen in FIGS. 2 and 3, through the slots (67). The fuel cell stack box (300) will have ventilation holes (180) spaced throughout the fuel cell stack box (300). At each end of the rows of fuel cells (200) are four set screw holes (131), which can be used for placement of set screws to “squeeze” the fuel cells (200) together to assure sealing of the fuel cells (200) so that the anode side of the MEA (50) is gas tight and there are no leaks of fuel (hydrogen) from the fuel cells (200). Typically, a squeeze plate (130) will be placed so that a set screw (not shown) placed in the set screw hole (131) will push the squeeze plate (130) in such a manner as to compress individual fuel cells (200) into a stack and to hold the stack in place inside the fuel cell stack (300). The squeeze plate (130) allows for fuel cells (200) to be added or removed from a stack. However, a set number of fuel cells (200) could be preassembled into a gas tight stack. The fuel cell (200A) facilitates the assembly of fuel cells (200A) into gas tight stacks. Ventilation holes (180) are placed throughput the fuel cell stack box (300) to ventilate the stacks of fuel cells (200) to dissipate waste heat and water vapor. The stack box (300), when coupled with the individual fuel cell design (200) and with appropriately regulated air feed and fuel feed into the fuel cell stack box (300) and thus, into the individual fuel cells (200), produces a high output design. A fuel cell stack box (300) of approximately 2″×2″×3″ can easily contain more than 120 fuel cells (200) or (200A). The conductive anode plate (80), the anode insulator (60), the MEA mounting film (52), the cathode insulator (65), and the cathode conductive plate (90) can all be constructed of thin materials so that the total thickness of any one fuel cell is quite thin. It is necessary that there be an appropriate supply of fuel (typically, hydrogen) through the fuel channels (6) and oxygen to the appropriate sides of the MEA (50). Because each individual fuel cell is thin, pressurized air is required for proper air flow over the cathode side of the MEA (50). The space (155) inside the two base plates (150) can distribute ionized air to each individual fuel cell (200) as required for maximum efficiency. This design allows each fuel cell to produce up to 0.95 volts with up to 1000 milliamps produced per square centimeter of MEA surface. This design allows the fuel cell stack box (300) to be approximately 2″2″×3″ with around 120-130 individual fuel cells (200) contained therein. When appropriately supplied with hydrogen gas and air, the fuel cell stack box (300) with the approximate 120-130 individual fuel cells (200) contained therein can produce up to 120 volts of direct current and with up to 17 amps of current flow. Except for some of the conductive elements, the entire assembly is made of lightweight plastic, thus, the total weight of the fuel cell stack box (300) is well under two pounds.

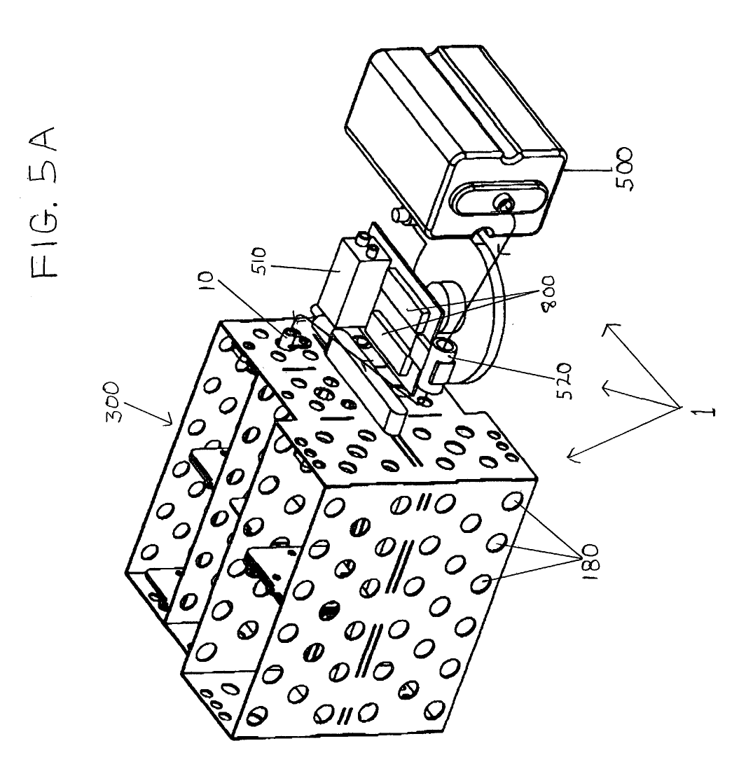

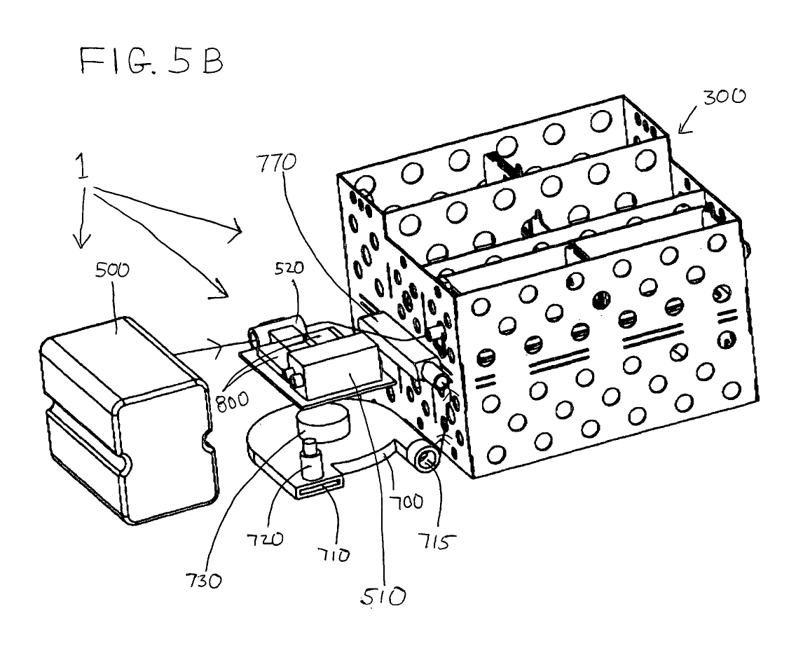

FIG. 5A shows the high-density fuel cell power unit (1) without a cover. At one end of the fuel cell power unit (1) is a fuel source in the form of a hydrogen storage unit (500). Currently, a variety of fuels may be used to power fuel cells, although hydrogen is one of the most efficient. Hydrogen can be stored in a variety of fashions in a compact battery-sized unit. Various hydrides can be used to store hydrogen and carbon nanotubes may be used as highly efficient hydrogen storage and are expected to be commercialized for hydrogen storage within a short time. Hydrogen will typically be stored above the ambient pressure of the air in the storage unit (500). As hydrogen is exhausted from the storage unit (500), it can be recharged from an ambient hydrogen source or replaced by a full storage unit (500). Pressurized hydrogen or some other fuel will exit the hydrogen storage unit (500), typically in a tube (not shown) leading to the fuel regulator valve (520). The fuel regulator valve (520) will be controlled by the control unit (800), typically printed circuit boards. From the fuel regulator valve (520) lines will lead to each fuel inlet (10) in the fuel cell stacks. Fuel will flow along the line shown by the arrows. In FIG. 5A only one fuel cell inlet (10) is shown, but it will be appreciated a fuel cell inlet (10) will be used for each row or stack of fuel cells. A battery (510) is shown mounted next to the control unit (800). A small battery may be necessary for initial power of the regulator valve (520) and control unit (800). However, once the fuel cells (200) are producing current, some current could be diverted for operation of the control unit (800) or, because only a small amount of electrical energy is required for operation, it could be operated off the battery (510) with the battery (510) being periodically replaced as needed. The solid state control unit (800) will control the start and stop for the unit, will be able to monitor fuel status, and can be timed for automatic shut-off. Monitoring of the high-density fuel cell power unit (1) output can also be done by the control unit (800). Typically, fuel cells will produce at a maximum efficiency if the MEA (50) is receiving the appropriate amount of hydrogen on the anode side of the MEA (50) and oxygen on the cathode side of the MEA (50). The regulator valve (520) can be used to modulate the flow of the fuel (hydrogen) to the fuel inlet (10) in each of the fuel cell stacks to make sure that the MEA's within each individual fuel cell (200) are operating at maximum efficiency.

FIG. 5B shows the high-density fuel power cell unit (1) from the opposite side of the view in FIG. 5A. Here, the air pump (700) is visualized more clearly. There is an air inlet (710). Mounted above the air inlet (710) is an ionizer unit (720). Typically, a flexible vane displacement air pump will be used, powered by a motor (730) mounted on top of the air pump (700). Ionized air will be pressurized by the air pump (700) and come out of the air outlet (715) which will be connected by appropriate tubing or other air transmission (not shown) means along the lines with arrows to the air manifold (770), which distributes the air between the two plates (150) (seen in FIG. 4), which distribute air through slots to the individual fuel cells (200) mounted within the fuel cell stack box (300). This pressurized ionized air assures maximum efficiency of the cathode side of the MEA (50) and removes waste water and heat. Again, the battery (510) can be used to power the motor (730) on the pump (700) initially with current being diverted from the high-density fuel cell power unit (1) as may be required. Again, the controller units (800) provide a means for accomplishing this if required. The ionizer (720) will operate off current produced either from the battery (510) or from the high-density fuel cell power unit (1). Where possible, components other than current carrying components will be molded plastic for their light weight and for their electrical and thermal insulating properties. The entire high-density fuel cell power unit (1) would be enclosed within a container (not shown) for safety purposes and to increase the durability of the unit. However, the power unit enclosure (not shown) could be easily disassembled to replace parts as required, including a fuel cell stack (200), the battery (510), the hydrogen storage unit (500), and so on. It is believed the provision of the forced air by the pump (700), which is pre-ionized by the ionizer (720), is capable of producing a high current flow per surface area of the fuel cells (200). It is expected the entire unit will be no more than 12 cubic inches with a weight under one pound, but nevertheless can produce up to 120 volts with peak current at more than 15 amps producing a peak power in the range of 2000 watts, sufficient to power many household appliances. It is believed in current technology more than 10 hours of power will be available without exhausting the hydrogen storage unit (500) with future technology promising much longer period of power before a recharging or replacement is required of the hydrogen storage unit (500).

A high-density fuel cell power unit (1) using stacks of fuel cells (200) or (200A) of the current design amounting to 12 cubic units in volume with appropriate control unit (800) and a hydrogen storage unit (500) can achieve a power output of approximately 2000 watts with 120 volts of direct current at 17 amps of current. Each MEA (50) in a fuel cell (200) or (200A) produces up to approximately 0.95 volts. To achieve 120 volts, 127 fuel cells (200) or (200A) would need to be stacked in series. Four stacks of fuel cells (200) or (200A) with 32 fuel cells (200) in each stack will mean that there are 128 fuel cells (200) or (200A) wired in series to produce up to the approximate 120 volts required. The MEA (50) will produce up to 1000 milliamps per square centimeter of cathode/anode surface. The control unit (800) can be set to control the fuel input of pressurized hydrogen from the storage unit (500) through the fuel regulator valve (520). Likewise, the air pump (700) and ionizer unit (720) produce pressurized ionized air for distribution to the cathode side of the MEA (50). The pump (700) can be controlled by the control unit (800). The control unit (800) can sense the power output produced by the fuel cell power unit (1) and can appropriately regulate through programming, the amount of fuel entering the high-density fuel cell power unit (1) and each stack of fuel cells (200) or (200A), while at the same time controlling the rate of flow of ionized air through each individual fuel cell (200) or (200A) to control waste water while maximizing efficiency of the MEA (50) in each fuel cell. The result is a lightweight, high-density fuel cell power unit (1) of less than two pounds. It is self-contained. It can be adopted for AC voltage or for use in the United States or Europe. It can be attached to handheld appliances such as irons, hair dryers, or the like. It can be easily switched on and off using a battery (510) for initial operation, with operation power being supplied by the high-density fuel cell power unit (1) itself. The control unit (800) may monitor the device for fuel leaks, for automatic shut-off, and to be sure that fuel quality and quantity is sufficient for operation of a unit. When encased in an appropriate lightweight plastic case, the high-density power unit (1) will be waterproof and can be used in indoor and outdoor applications and submersion of the unit in water will ordinarily not harm the operation of the unit. With current hydrogen storage technology, enough hydrogen can be stored in a storage unit (500) that will be substantially smaller than the entire unit itself, so that the high-density power unit (1) can produce hours of electrical power sufficient to operate small appliances.

I claim:

1. A fuel cell assembly design for ease of combination and stacking into compact fuel cell stacks to supply electrical power at useful current and voltages comprising:
(a) a conductive anode plate of a definite size and shape having at least one conductive anode plate opening therein for transmission of hydrogen gas;
(b) an anode insulator of a definite size and shape adjacent to said anode plate, said anode insulator having at least one anode insulator opening in said anode insulator matching said conductive anode plate opening in said conductive anode plate wherein hydrogen gas is transmitted through said anode insulator opening and distributed to a first side of a membrane electrodeassembly, and having at least one anode insulator slot for oxygen distribution;
(c) a mounting film of a definite size and shape with a first side of said mounting film adjacent to said anode insulator; wherein on said mounting film said membrane electrodeassembly is mounted, with said mounting film having at least one membrane film opening therein matching at least a portion of said anode insulator opening for transmission of hydrogen gas; and having at least one mounting film slot for oxygen distribution
(d) a first means for conductively connecting said membrane electrodeassembly on said first side of said mounting film to said conductive anode plate;
(e) a cathode insulator of a definite size and shape mounted adjacent to a second side of said mounting film, with at least one cathode insulator opening, matching said membrane film opening, for transmission of hydrogen gas, and with at least one cathode insulator slot for oxygen distribution to said membrane electrodeassembly;
(f) a conductive cathode plate adjacent to said cathode insulator, said conductive cathode plate of a definite size and shape with a cathode plate opening matching said cathode insulator opening, for transmission of hydrogen gas;
(g) a second means for conductively connecting said membrane electrodeassembly on said second side of said mounting film to said conductive cathode plate;
wherein hydrogen may be distributed to first side of said membrane electrodeassembly, oxygen may be distributed to second side of said membrane electrodeassembly producing water and an electrical current.

2. A fuel cell assembly design of claim 1 wherein said definite size and shape for said conductive plate anode, said anode insulator, said mounting film, said cathode insulator, and said conductive cathode plate are the same whereby said conductive anode plate, anode insulator, mounting film, first means for conductive connection, cathode insulator, conductive cathode plate, and second means for conductive connection may be assembled into a compact fuel cell assembly of said definite size and shape and easily conductively connected to at least one second fuel cell assembly of said definite size and shape whereby said first and at least one second fuel cell assemblies may be conductively connected in series to produce a definite voltage.

3. A fuel cell assembly design of claim 2 wherein said at least one anode insulator slot, said at least one mounting film slot, and said at least one cathode insulator slot provide a passageway for oxygen from a first side of said fuel cell assembly to a second side of said fuel cell assembly wherein oxygen passes over said second side of said membrane electrodeassembly.

4. A fuel cell assembly design of claim 3 wherein said second means for conductively connecting is a conductive mesh plate conductively mounted against said membrane electrodeassembly on said second side of said mounting film and conductively connected to said conductive cathode plate.

5. A fuel cell assembly design of claim 4 wherein said fuel cell can generate up to 1000 milliamps per square centimeter of said membrane electrodeassembly surface.

6. A fuel cell assembly design of claim 5 wherein said fuel cell membrane electrodeassembly can produce up to 0.95 volts.

7. A fuel cell assembly design of claim 2 which further includes means for a gas tight assembly of said conductive anode plate, said anode insulator, said mounting film, said first means for conductive connection, said cathode insulator, said conductive cathode plate and said second means for conductive connection.

8. A fuel cell assembly design of claim 7 wherein said conductive anode plate and said conductive cathode plate are, in part, coated with metallized material on a first side and on a second side.

9. A fuel cell assembly design of claim 8 wherein said metallized material on first side is conductively connected to said metallized material on said second side.

10. A fuel cell assembly design of claim 9 wherein said first means for conductively connecting is a metallized grill on said anode insulator whereby a conductive connection is possible between said conductive anode plate through said metallized grill on said anode insulator to said membrane electrodeassembly.

11. A fuel cell assembly design of claim 10 wherein said second means for conductively connecting is a conductive mesh plate conductively mounted against said membrane electrodeassembly on said second side of said mounting film and conductively connected to said metallized material on said conductive cathode plate.

12. A fuel cell assembly design of claim 11 wherein said fuel cell can generate up to 1000 milliamps per square centimeter of said membrane electrodeassembly surface.

13. A fuel cell assembly design of claim 12 wherein said fuel cell membrane electrodeassembly can produce up to 0.95 volts.

14. A high-density fuel cell power supply comprising:
(a) means for storing hydrogen fuel;
(b) a plurality of fuel cells stacked together, each fuel cell having a membrane electrodeassembly with an anode side for exposure to the fuel and a cathode side for exposure to air;
(c) means for distributing fuel to said anode side of each fuel cell in said plurality of fuel cells;
(d) means for delivering air to said cathode side of said fuel cell in said plurality of fuel cells;
(e) a microprocessor control means for controlling said means for delivering fuel and said means for delivering air to said high-density power supply;
whereby each fuel cell in each said stack of fuel cells can generate up to 0.95 volts for each fuel cell and for said membrane electrodeassembly in said fuel cell, a current of up to 1000 milliamps may be produced for each square centimeter of surface of said membrane electrodeassembly.

15. A high-density fuel cell power supply of claim 14 wherein the said means for delivering air to said cathode side of said fuel cell is a forced air exchanger whereby said high-density fuel cell power supply is cooled and waste water is removed from said high-density fuel cell power supply by said forced air exchanger.

16. A high-density fuel cell power supply of claim 15 wherein said high-density fuel cell power supply is designed for portable power needs including power tools, household appliances, and personal care appliances wherein said plurality of fuel cells are approximately 12 cubic inches producing an electrical voltage of up to 120 volts, an electrical current of up to 17 amperes and a power output of up to 2000 watts at maximum production.

17. A high-density fuel cell power supply wherein individual fuel cells in said fuel cell power supply are a fuel cell assembly design of claim 2, said fuel cell power supply further comprising:
(a) a means for storing hydrogen fuel;
(b) a plurality of fuel cells of claim 2 stacked together;
(c) means for distributing fuel to said anode side of each of said fuel cells in plurality of fuel cells.
(d) means for delivering air to said cathode side of said fuel cell in said plurality of fuel cells;
(e) a microprocessor control means for controlling said means for delivering fuel and said means for delivering air to fuel cells in said high-density power supply.

18. A high-density fuel cell power supply of claim 17 wherein said means for delivering air to said cathode side of said fuel cell is a forced air exchanger where high-density fuel cell power supply is cooled and waste water is removed from said high-density fuel cell power supply by said forced air exchanger.

19. A high-density fuel cell power supply of claim 18 wherein said high-density fuel cell power supply is designed for portable power needs including power tools wherein said plurality of fuel cells are approximately 12 cubic inches in volume producing an electrical voltage of up to 120 volts and electrical current up to 17 amperes and a power output of up to 2000 watts.
